(19) United States
(12) Patent Application Publication
(10) Pub. No.: US 2007/0162297 A1
(43) Pub. Date: Jul. 12, 2007

(54) Information processing apparatus and case example output method and program

(75) Inventors: Haruko Yakabe, Inagi (JP); Kojin Yano, Yokohama (JP); Nozomi Uchinomiya, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/540,077

(22) Filed: Sep. 28, 2006

(30) Foreign Application Priority Data
Oct. 13, 2005 (JP) 2005-299207

(51) Int. Cl. G06Q 99/00

(52) U.S. Cl. 705/1

(57) ABSTRACT

An information processing apparatus capable of outputting a case example(s) satisfying the needs of customers without inputting keywords is disclosed. The apparatus includes an output device, an action needs storage unit for storing needs information indicating the customer needs in correspondence to action information indicating action contents of the customers at a service providing location, a database for storage of the needs information and case example information representing case examples in past for the needs in a correspondence manner, a needs acquisition unit for receiving the action information and for reading from the action needs storage unit the needs information corresponding to the received action information, a case example acquisitor for reading from the database the case example information corresponding to the needs information thus read, and a case example output unit for outputting to the output device the readout case example information in a list format.

### INCORPORATION BY REFERENCE

The present application claims priority from Japanese application JP2005-299207 filed on Oct. 13, 2005, the content of which is hereby incorporated by reference into this application.

### BACKGROUND OF THE INVENTION

The present invention relates to an information processing apparatus, a case example output method, and a software program for use therein.

In business entities which provide customers with services, an attempt is made to obtain suggestions for determination of a method and a policy of system design for providing services to meet the needs of customers through analysis of presently suffering problems while referring to examples of similar cases in the past, i.e., precedents. Various types of systems used for such determination have been contrived until today. An example of these systems is disclosed in JP-A-2005-141586, which is a system for acquiring business operation information from patent information open to the public and for categorizing it into industry fields.

### SUMMARY OF THE INVENTION

In prior known systems, a need is felt to input one or more keywords in order to conduct a search for similar case examples. However, it is difficult for service providers to judge which kind of keywords are suitable. Accordingly, there will possibly happen depending upon how to choose such keywords a situation that unexpected case examples far from the needs of customers are output and a situation incapable of sufficiently searching for expected case examples which can meet the customer needs.

This invention has been made in view of the above technical background, and an object of the invention is to provide an information processing apparatus, a case example output method and a software program for use therein, which are capable of outputting a case example that is deemed best fit to the customer needs.

To attain the foregoing object, an information processing apparatus for output of case examples in the past is provided. This apparatus includes an output device, an action needs storage unit for storing therein needs information indicative of needs of customers in a way corresponding to action information indicating action contents of the customers at a service providing location, a case example database for storage of the needs information and case example information representing case examples in past with respect to the needs in a correspondence manner, a needs acquisition unit for receiving input of the action information and for reading from the action needs storage unit the needs information corresponding to the received action information, a case example acquisition unit for reading from the case example database the case example information corresponding to the needs information thus read, and a case example output unit for outputting to the output device the case example information thus read in a list-like format.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an overall configuration of a case example searching system.

FIG. 2 is a diagram showing a hardware configuration of an image analyzing device 10.

FIG. 3 is a functional block diagram of the image analyzing device 10.

FIG. 4 is a diagram showing one example of detection information.

FIG. 5 is a hardware configuration diagram of a case example output device 20.

FIG. 6 is a functional block diagram of the case example output device 20.

FIG. 7 is a diagram showing a configuration of an action pattern database 251.

FIG. 8 is a diagram showing an arrangement of a needs database 252.

FIG. 9 is a diagram showing a configuration of a coping measure database 253.

FIG. 10 is a diagram showing a configuration of a case example database 254.

FIG. 11 is a diagram showing a flow of a processing procedure by means of the case example output device 20.

FIG. 12 is a diagram showing one example of a display screen 510 for output of action contents, needs and coping measures.

FIG. 13 is a diagram showing one example of a display screen 520 for output of case examples.

### DETAILED DESCRIPTION OF THE INVENTION

System Configuration

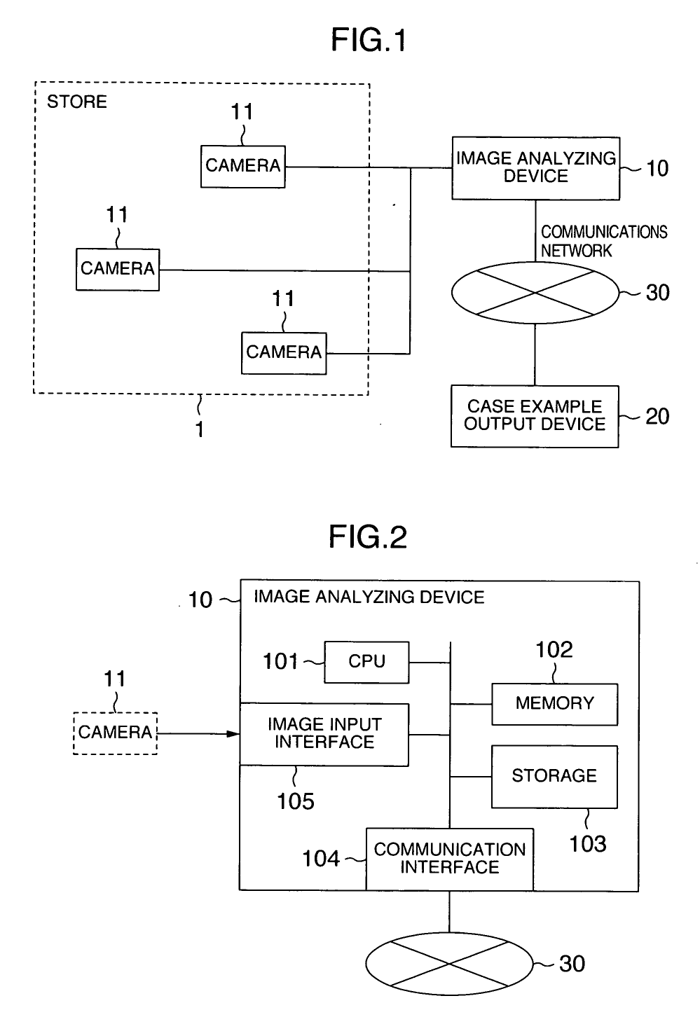

FIG. 1 is a diagram showing an entire configuration of a case example search system including a case example output device 20 in accordance with an embodiment of this invention. In the case example search system of this embodiment, its major functionality is to analyze video images of surveillance cameras 11 as installed in a store 1 of a retail shop, such as a supermarket or a convenience store or the like, for monitoring the behavior of shopping persons, such as customers, and estimate the needs of the customers in accordance with their body actions and behaviors, and then search for examples of model cases in the past or “precedents” for the needs estimated. The illustrative embodiment assumes that a manager of the store 1 performs the planning of services for choppers or customers to be provided at the store 1 while referring to earlier case examples as output from the case example output device 20.

As shown in FIG. 1, the case example search system of this embodiment is arranged to include an image analyzing device 10 and a case example output device 20. The image analyzing device 10 and the case example output device 20 are communicably connected together via a communications network 30. Examples of the communications network 30 are the Internet, a local area network (LAN), public telephone line network, and radio communication network.

The image analyzing device 10 and the case example output device 20 are computers, such as personal computers (PCs) or workstations, for example. The image analyzing device 10 is operative to receive and accept video images from the surveillance cameras 11 that are installed in the store 1, analyze motions of shoppers or customers from the received video images, and then send its pattern (referred to hereinafter as motion pattern) toward the case example output device 20. The case example output device 20 performs management of information indicating earlier case examples, i.e., precedents, of various kinds of services including other industry fields and, upon receipt of a motion pattern of a customer to be sent from the image analyzing device 10, searches for output a case example that is deemed to be best fit to the motion of the customer.

Image Analyzing Device 10

FIG. 2 is a diagram showing a hardware configuration of the image analyzing device 10. As shown herein, the image analyzing device 10 includes a central processor unit (CPU) 101, a memory 102, a storage device 103, a communication interface 104, and an image input interface 105.

The storage device 103 is for storage or recording of software programs and data, such as for example a hard disk drive (HDD) or a compact disc read-only memory (CD-ROM) drive. The CPU 101 reads a software program being stored in the storage device 103 into the memory 102 and then executes it, thereby realizing various functions. The communication interface 104 is an interface for connection to the communications network 30. Examples of the interface 104 are an Ethernet (registered trademark) adapter and a modem or else. The image input interface 105 operates to acquire video image data from the cameras 11; for example, a video capture card or like components.

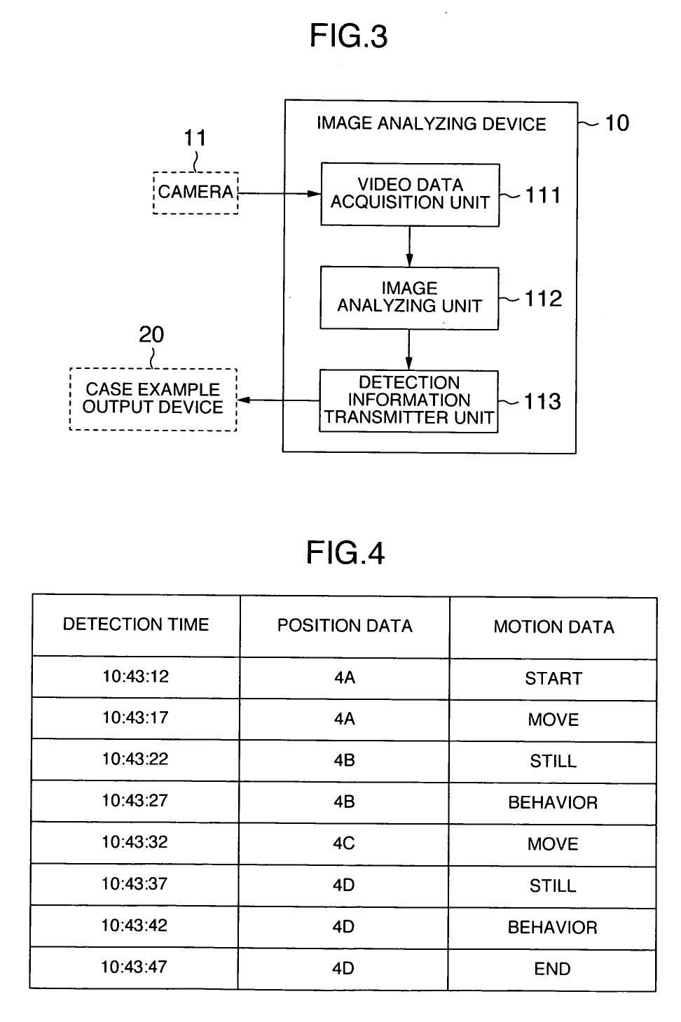

FIG. 3 is a functional block diagram of the image analyzing device 10. As shown herein, the image analyzing device 10 includes a video data acquisition unit 111, image analyzing unit 112, and detection information transmitter unit 113. Note here that these respective function units 111-113 are realizable by the CPU 101 of image analyzing device 10 that functions to read the program out of the storage device 103 into the memory 102 and then execute it.

The video data acquisition unit 111 acquires video data from the cameras 11 periodically. For example, the video data acquisition unit 111 receives from a camera 11 a video signal of the national television system committee (NTSC) format and then sends it to the memory 102 via the image input interface 105 for storage therein as digital data.

The image analyzing unit 112 analyzes the video data as acquired at the video data acquisition unit 111 to thereby specify motion data indicative of a series of motions in units of shopping persons. Suppose that the image analyzing unit 112 analyzes customer's motions by use of standard image analysis processing techniques. Typical examples of the motion data include, but not limited to, “Still” which indicates the stillness of a customer, “Move” which indicates that a customer moves his or her position by walking or running, and “Action” indicating that a customer moves his or her limb while standing at the same position. Note here that the image analyzing unit 112 may be arranged so that by taking into consideration a facility layout and the kind of goods on shelves plus various exhibits in the store 1, determination may be made for example to regard as “Action” when a customer stands still against a showcase or s/he comes face to face with another person even in case the customer is in the “Still” state.

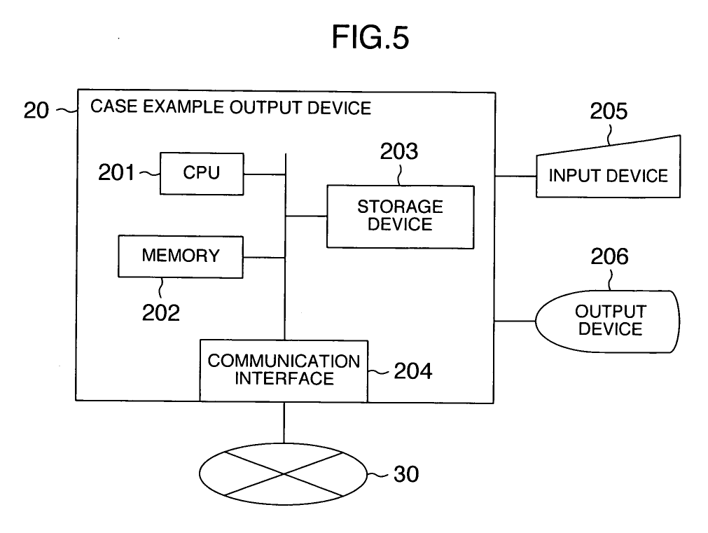

The detection information transmitter unit 113 sends the information that contains the image analyzing unit 112's analyzed history of motion data (i.e., motion pattern) to the case example output device 20. The information will be referred to hereinafter as detection information, one example of which is shown in FIG. 4. As shown herein, the detection information includes position data indicating the positions of customers in the store 1 and time points (detection time points) at which the image analyzing unit 112 has detected prespecified kinds of motions and motion data indicating such motions of the customers. An example of the position data is information indicative of a block position in the store 1 or a latitude/longitude coordinate system.

Case Example Output Device 20

FIG. 5 depicts a hardware configuration of the case example output device 20. As shown herein, the case example output device 20 includes a CPU 201, memory 202, storage device 203, communication interface 204, input device 205, and output device 206. The storage device 203 is for the storage or recording of software programs and data, such as for example an HDD or CD-ROM drive or else. The CPU 201 reads a software program being stored in the storage device 203 into the memory 202 and then executes it, thereby realizing various functions. The communication interface 204 is for connection to the communications network 30. Examples of interface 204 are an Ethernet™ adapter and a modem or else. The input device 205 is for receipt of data input from a user, such as for example a keyboard, a pointing device called the “mouse,” a touch-sensitive panel or like data entry tools. The output device 206 is for output of data, e.g., a display or a printer.

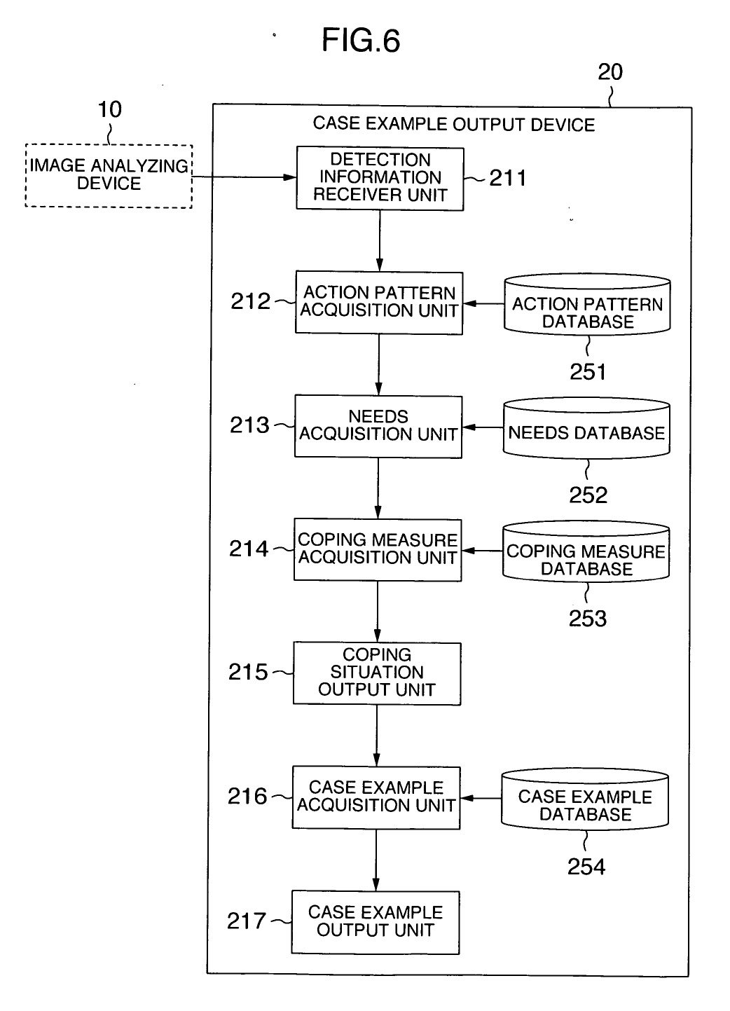

FIG. 6 is a functional block diagram of the case example output device 20. As shown herein, the case example output device 20 includes respective function units such as a detection information receiver unit 211, action pattern acquisition unit 212, needs acquisition unit 213, coping measure acquisition unit 214, coping situation output unit 215, case example acquisition unit 216 and case example output unit 217, and respective storage units such as an action pattern database 251, needs database 252, coping measure database 253, and case example database 254. Note that the above-noted respective function units 211-217 are realizable by causing the CPU 201 of case example output device 20 to read the program from the storage device 203 into the memory 202 and then execute it. The storage units 251-254 are realized as storage areas to be provided by the memory 202 and/or the storage device 203 of the case example output device 20.

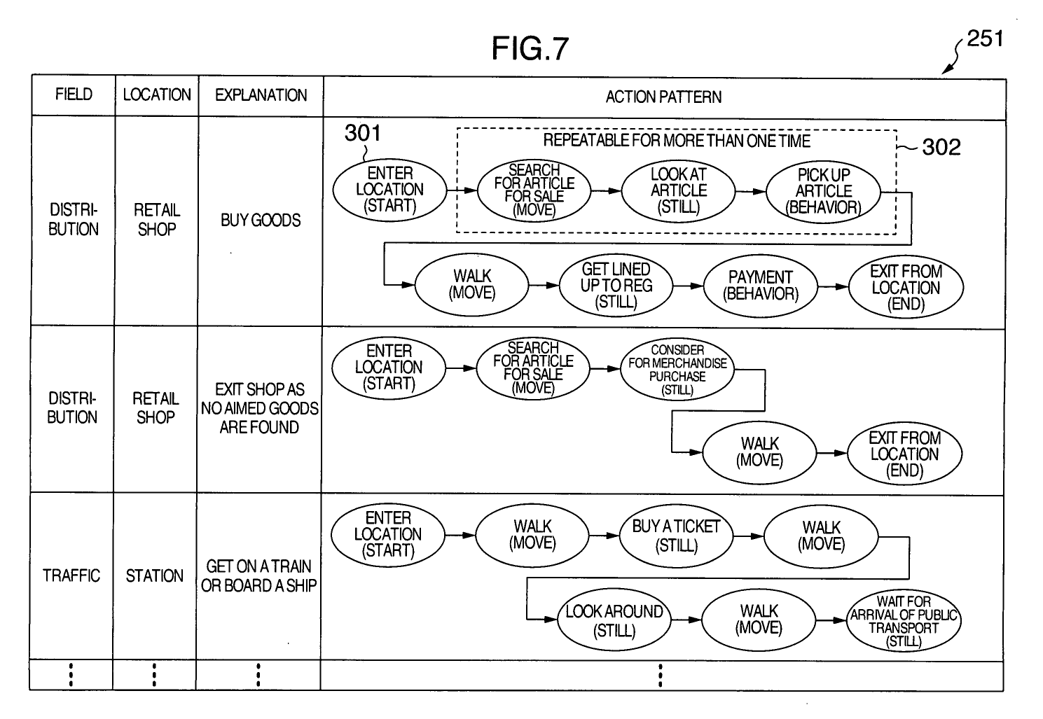

The action pattern database 251 stores therein patterns of action contents such as in purchase acts of shoppers or customers, which will be referred to as “action patterns” hereinafter. See FIG. 7, which shows an exemplary arrangement of the action pattern database 251. As shown herein, the action pattern database 251 stores the industry fields of services, providing locations, explanations of action patterns, and action patterns in a mutual correspondence fashion. As shown in FIG. 7, an action pattern is made up of more than two action contents 301 in a chronological or “time-series” manner. Each of the action contents to be included in the action pattern is associated with motion data which indicates the motion of a customer in such the action content. In the example of FIG. 7, an action content 301 of “Enter Location” is associated with motion data of “Start” as added thereto. It also includes a description of a repeat 302 of more than two action contents 301. It should be noted that although in FIG. 7 the action patterns are described by use of symbols for brevity purposes, this is not a limitative one. It is also possible to use other notational methods based on mathematical formulas, e.g., a condition-added probability distribution P(Y|X) Additionally, the action pattern database 251 pre-stores therein those action patterns that are considered to be typical as customer's acts, which are registered in advance thereto.

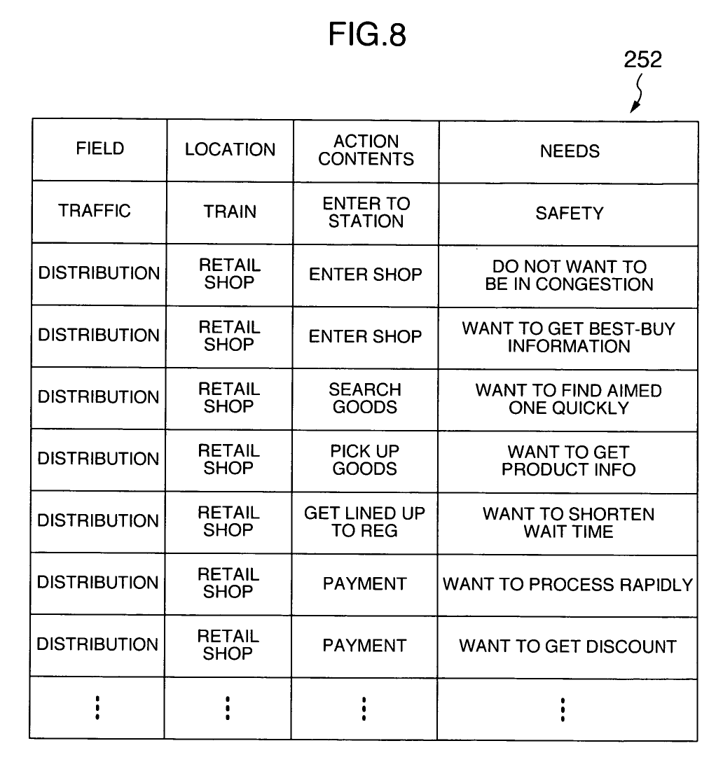

The needs database 252 is for management of needs corresponding to the action contents of shopping persons, e.g., customers. See FIG. 8 which shows an exemplary structure of the needs database 252. As shown herein, the needs database 252 stores service fields, service providing locations, customers' action contents and their needs in a mutually correlated manner. The needs database 252 is also arranged so that the needs which are potentially occurrable due to the action contents are registered thereto. In addition, when new needs take place through questionnaire to customers, such needs are registered to the needs database 252.

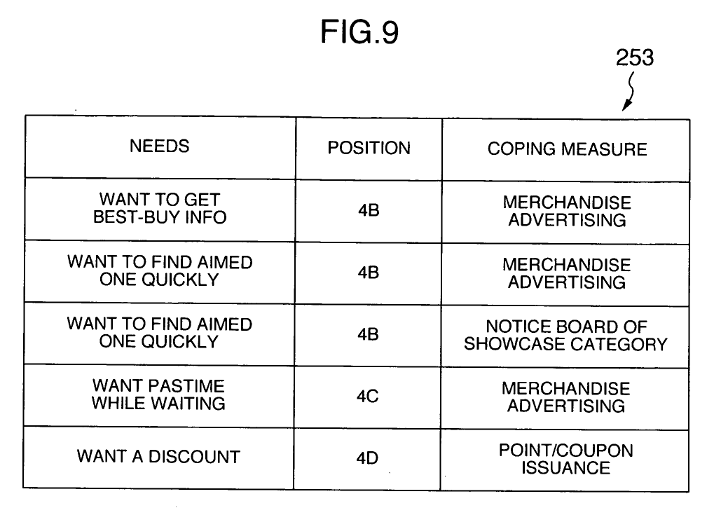

The coping measure database 253 stores several coping measures or countermeasures to the customer needs, which are provided at the store 1. See FIG. 9, which shows a structure of the coping measure database 253. As shown herein, this database 253 stores information indicative of positions of the store 1, i.e., position data, and presently implemented coping measures or service guidelines in a way corresponding to the customer needs.

Examples of the coping measures as registered to the coping measure database 253 include the so-called “static” services, such as in-store notices or services at a service counter, which are routinely provided at the store 1, and the so-called “dynamic” services to be opportunistically provided depending on time zones and the service provider's strategy, such as a time service, wagon sale, etc. These coping measures are registered in advance to the coping measure database 253 after the researching of an investigator(s) through visual observation and/or hearing or else. Additionally it may also be arranged to register coping measures to the coping measure database 253 in an automated way, by causing the image analyzing device 10 and/or the case example output device 20 to analyze video data from the cameras 11 being installed in the store 1 to detect that a salesperson begins a prespecified work operation or detect that a wagon(s) is/are prepared, by way of example.

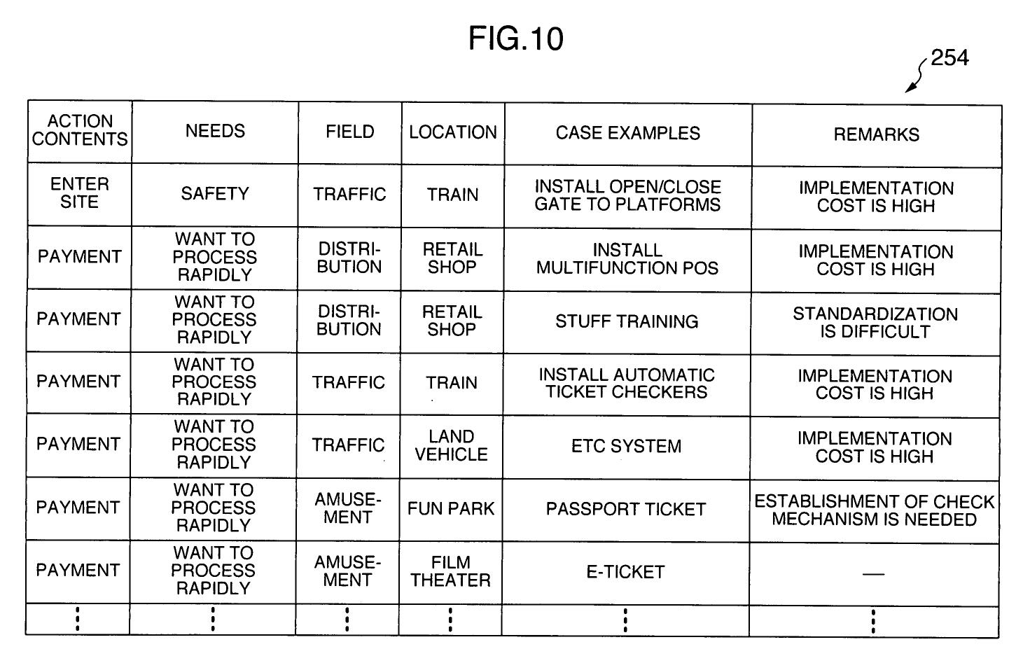

The case example database 254 handles for management those earlier examples of model cases—namely, precedents—to the needs of customers. FIG. 10 shows a structure of the case example database 254. As shown herein, the case example database 254 stores therein action contents, needs, service fields, service-providing locations, case examples and remarks in a mutual correspondence fashion. The case examples to be registered to this database 254 may also include case examples in other industry fields, which are different from the field of the store 1.

The detection information receiver 211 receives detection information as sent from the image analyzing device 10. The action pattern acquisitor 212 performs matching with motion patterns included in the detection information, for a respective one of the action patterns being registered to the action pattern database 251 and then acquires from the action pattern database 251 an action pattern that is similar to the motion pattern of the detection information. For instance, in the example of the detection information shown in FIG. 4, several motion patterns are contained, such as “Start,” “Move,” “Still,” “Action,” . . . , “End.” In the example of the action pattern database 251 shown in FIG. 7, this motion pattern matches an action pattern at an uppermost part of the table list. Additionally the action pattern acquisitor 212 may be arranged to acquire a plurality of action patterns at a time.

The needs acquisitor 213 reads out of the needs database 252 those corresponding needs relative to respective action contents of the action pattern as gained by the action pattern acquisitor 212. Regarding the needs corresponding to respective action contents of the action pattern as obtained by the needs acquisitor 213, the coping measure acquisitor 214 reads from the coping plan database 253 both a coping measure against such needs and position data indicative of the position at which the coping measure is implemented. The coping situation output unit 215 outputs to the output device 206 the coping measure that was acquired by the coping measure acquisitor 214.

For the above-noted respective action contents of the action pattern gained by the action pattern acquisitor 212, the case example acquisitor 216 acquires from the case example database 254 the case example information that corresponds to the needs thus obtained by the needs acquisitor 213. The case example output unit 217 outputs to the output device 206 the case example information as gained by the case example acquisition unit 216. Note here that in this embodiment, the case example output unit 217 is designed to output the case example information only when any coping measure satisfying the needs corresponding to the customer's action contents is not provided as will be described later. Additionally a detailed explanation of the output processing of the case example information will be set forth later.

Processing

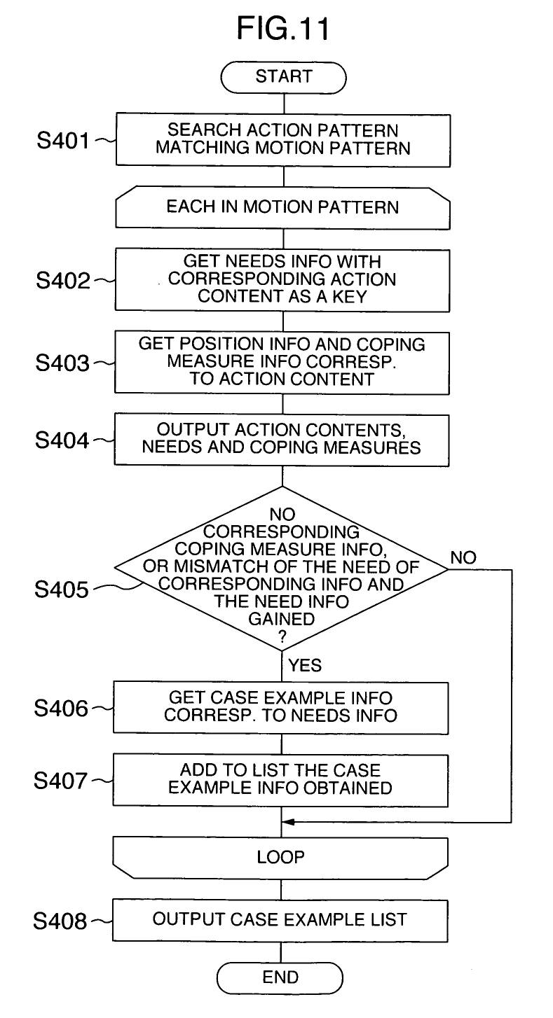

FIG. 11 is a diagram showing a flow of the processing to be executed by the case example output device 20 of this embodiment.

The case example output device 20 is responsive to receipt of the detection information as sent from the image analyzing device 10, for reading out of the action pattern database 251 an action pattern which matches the motion pattern as included in the received detection information (at step S401). For a respective one of motion data making up the motion pattern of the detection information, the case example output device 20 performs the processing in a way which follows.

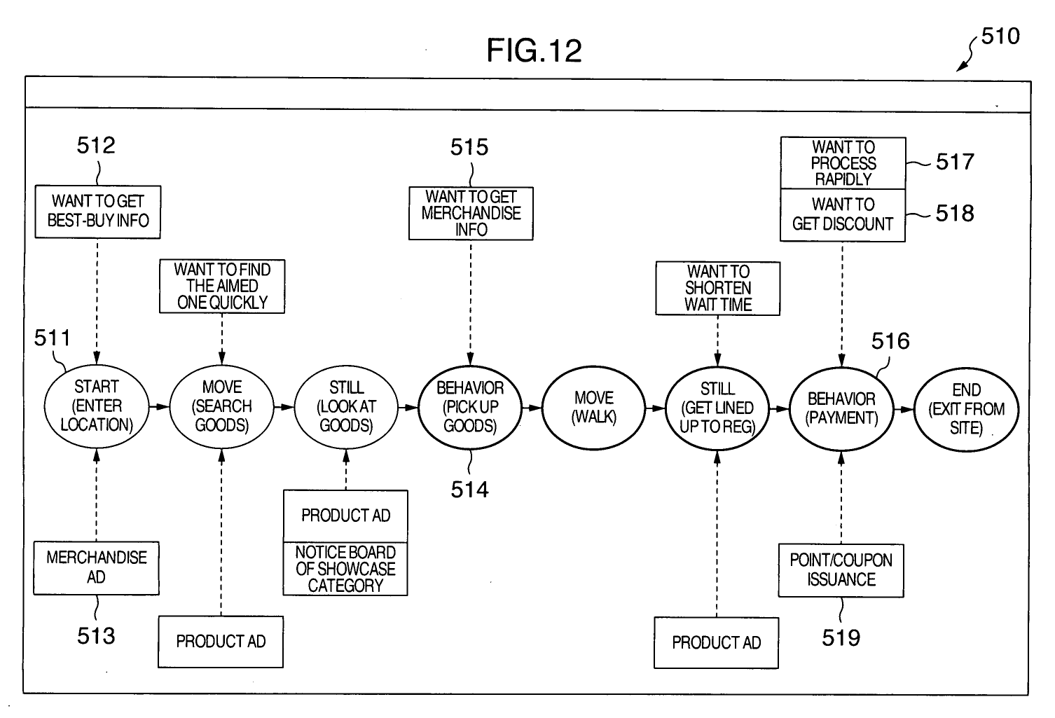

The case example output device 20 specifies from the action pattern an action content corresponding to the motion data and then reads needs from the needs database 252 with the specified action content being as a key (at step S402). The case example output device 20 reads a coping measure(s) from the coping measure database 253 while using as keys the position corresponding to the motion data of the detection information and the above-noted action content (step S403). The case example output device 20 outputs the action content and the needs plus the coping measure to the output device 206 (S404). One example of a display screen 510 is shown in FIG. 12, which is for output of the action content, the needs and the coping measure. Shown in FIG. 12 is an example of the screen 510 which is output to a display device, such as a liquid crystal display (LCD) panel. On the screen 510, needs are displayed at an upper part, an action pattern is at an intermediate part, and coping measures are at a lower part in a mutually correlated manner. For example, in a way corresponding to an action content 511 of “Enter Location,” a need 512 of “Want to get best-buy information” is displayed at the upper part on the screen, with a coping measure 513 of “Merchandise advertising” is displayed at the lower part.

The case example output device 20 processes the action content corresponding to the motion data in such a way that when any coping measure corresponding to the needs is not registered to the coping measure database 253, or alternatively when a coping measure as to part of a plurality of needs is not registered to this database 253 (i.e., if YES at step S405), the device reads case example information corresponding to such needs from the case example database 254 (step S406) and then adds the read case example information to a list of case examples (S407).

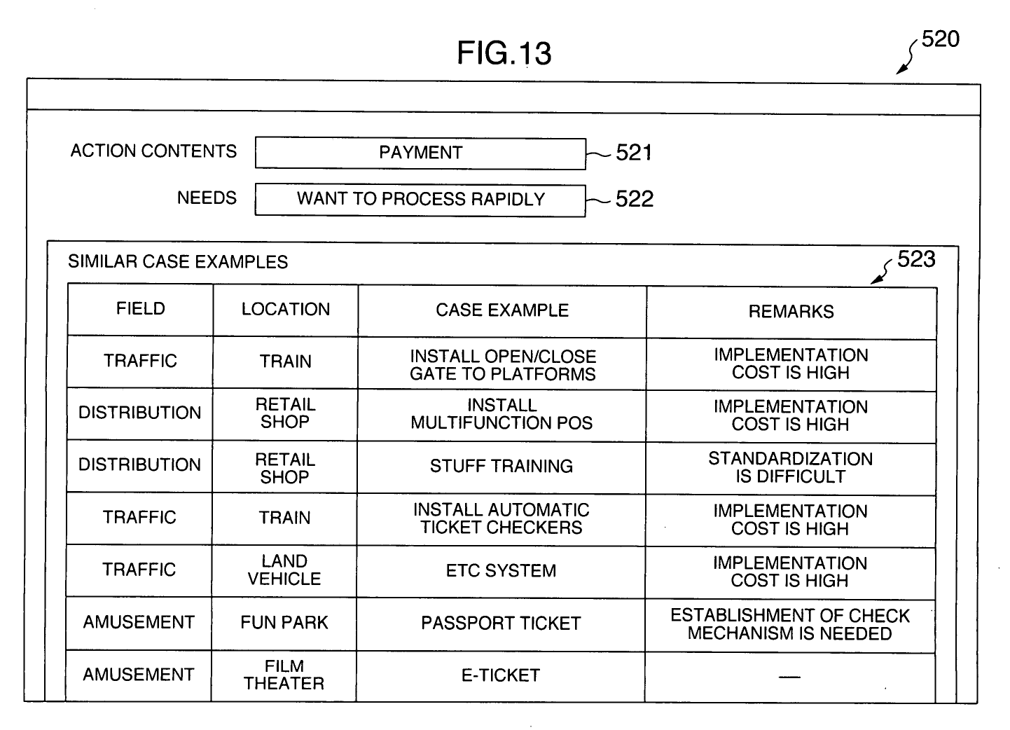

Upon execution of the above-noted processing for each motion data, the case example output device 20 outputs the case example list to the output device 206 (S408). One example of a display screen 520 which outputs case examples is shown in FIG. 13. In FIG. 13, an example of the screen 520 to be output to the display device. The screen 520 visually indicates a list-up table including an action content entry box 521, a need entry box 522, and a list indication area 523 of case example information. In the case example info list indication area 523, several case examples are displayed which correspond to the action content and need that are indicated in the entry boxes 521 and 522.

In this way, the case example search system of this embodiment estimates the need of a customer from his or her body motion which is detected by analysis of a video image that is captured by the camera 11 as installed in the store 1 and thus is capable of outputting an earlier case example with respect to the estimated need in case a service for such need is not provided. In this way, it is possible for the case example search system of this embodiment to output a collection of hints or “tips,” which serve as informative reference for service planning. This makes it possible for a service planner in the store 1 to obtain, from the above-noted output, ideas or suggestions for the planning of a newly provided service. Thus it is possible to make the newly provided service in the store 1 more than adequate for customer needs.

For example, on the screen 520 shown in FIG. 13, several case examples are displayed, which meet the need of “Want to process rapidly” when a customer makes “Payment.” The service planner draws upon “ETC System” which is a case example in the industry field of transportation, for example, thereby enabling execution of his or her planning, such as introduction of the so-called the “self-registering,” which is a fee payment regime without the need for cash register operations by an employee in the store 1 that is a retail shop. In this case, in a similar way to “ETC System,” it becomes possible by preparing two types of lanes for manned cash registering and self-registering corners to direct those customers who require salesperson-assisted fee payment to the manned registering corner while directing the others to the self-registering corner, thereby enabling achievement of efficient payment processing.

In addition, the case example search system of this embodiment is arranged to perform management with the customer needs being as a key, so it is possible to exhaustively search for every case example corresponding to the customer needs. Thus it is possible to perform effective planning of services that serve the customer needs.

Additionally, in the case example search system of this embodiment, it is unnecessary to enter key words, which has been required in prior known similar case example search systems. Thus it is possible for users to readily perform their intended case example search-up. It is also possible to preclude occurrence of output of unexpected case examples far from the needs in a way depending on how to choose a keyword and, adversely, eliminate the inability to search a sufficient number of case examples.

Additionally, in the case example search system of this embodiment, case examples being provided in the store of interest are displayed in a table list format while letting them correspond to action patterns of shoppers or customers. Thus, referring to this output makes it possible for the manager or the service planner or else of the store 1 to readily affirm whether adequate services satisfying the customer needs are presently provided in the store 1 and what is being provided if such services are provided.

Additionally the case example search system of this embodiment is arranged to output those earlier case examples relating to only certain needs with no coping measures therefor being implemented in the store 1. For example, in the above-noted example of FIG. 12, the display screen 510 indicates that a need 515 is present for an action content 514 of “Picking up goods” but no coping measures are available therefor. Regarding an action content 516 of “Payment,” a need 517 of “Want to process rapidly” and a need 518 of “Want to make a discount” exist while indicating that no coping measures are available for the need 517 although a coping measure 519 of “Service-point/coupon issuance” is present for the need 518. In this case, for the motion data of “Action” corresponding to the action contents 514 and 516, case example information corresponding to the need 515 of “Want to get merchandise information” and case example information corresponding to the need 517 of “Want to process rapidly” are added to the case example list.

In the way stated above, the case example search system of this embodiment is capable of outputting an appropriate number of earlier case examples only for those with a gap between the customer needs and the services being provided in the store 1. More specifically, it is possible for the case example search system of this embodiment to selectively output certain case examples which bring a hint or clue about unsatisfied needs even in case where a great number of earlier case examples are registered. This makes it possible for the service planner in the store 1 to effectively perform, by selection of proper ones from among such large number of case examples, the planning of a new service(s) satisfying the customer needs that are not adopted yet in the store 1.

Although in the prior art there are risks as to unwanted restriction of service fields to be searched resulting in the lack of an ability to obtain any helpful hints in case any similar examples are absent in the same field in the past and a capability of becoming aware of a new approach which has been performed in other fields but is not done in the same field, it is possible in the case example search system of this embodiment to conduct a search with the customer needs being as a key while at the same time targeting case examples in various fields without limiting it to the same kind of field as that of the store 1. Thus, it is possible for the service planner to perform the planning of a new service(s) to be provided in the store 1 while referring to an increased number of case examples which satisfy the customer needs. For example, concerning the need of “Want to process rapidly” in the customer's action of “Payment,” in addition to “Introducing multifunction POS” and “Training of salesperson” which are case examples in a category of “Retail shop” in the same field of “Distribution in commerce” in the prior art, it is possible to conceive a new service at the retail shop while referring to case examples such as “Automated entranceway” and “ETC system” in the field of “Transportation” along with “Passport/Ticket” and “e-Ticket” in the field of “Amusement.” Hence, it is possible for the service planner to get hints for new creation of ideas for appreciable differentiation from shareholders in the same field by widely referring to case examples of success in other fields.

Although this embodiment is arranged to analyze video data from the cameras 11 for detection of the motions of customers, this is not to be construed as limiting the invention. An example of other employable approaches is that a microphone is installed in the store 1 for analyzation of audio data. Another example is that texts and/or numerical values are acquired which are input by customers to a POS terminal or an information providing tool. Yet another example is that IC tags are attached or pasted to shopping carts or members cards for storage of identification (ID) data while installing in stores readers for readout of the ID data as stored in IC tags to thereby detect motions of customers. Furthermore, an attempt may be made to combine together these various types of data.

While this embodiment is arranged to use general needs of ordinary shopping persons, it may be arranged to analyze those needs of a limited segment of customers only. An exemplary scheme used in this case is that the needs database 252 is modified to store such needs in addition to the fields, locations and action contents while letting the needs correspond to specific properties, such as sexuality and age indicating the customer segment while permitting the image analyzing device 10 to analyze from image data the sexuality and age of a customer. If this is the case, it is possible to output case examples for the needs on a per-customer segment basis. Thus it is possible for the service planner to get hints for the planning of a more satisfiable service.

While this embodiment is under an assumption that the coping measures which are implemented in the store 1 are registered in advance to the coping measure database 253 while letting them correspond to several positions within the store 1, an approach is employable for arranging the coping measure database 253 to store action patterns of employees in the store 1 in a similar way to the action patterns of customers while designing the image analyzing device 10 to analyze video data to detect the behavior of employees through detection of their uniforms by way of example to thereby estimate the coping measures being provided at the store 1 by means of the matching of a motion pattern of an employee and his or her action pattern.

Although the embodiment is arranged to skip the output of earlier case examples satisfying the customer needs in case the coping measure for such needs is implemented, i.e., when the coping measure corresponding to the needs has already been registered to the coping measure database 253, it may be arranged to output the case examples even in cases where the coping measure is implemented. In this case, even when the coping measure is implemented, it is possible for the service planner to perform the planning for improvement of such service. Thus, it becomes possible to improve the service quality to be provided at the store 1.

Additionally the case example output device 20 may be arranged to determine from the customer motion patterns whether the customer needs are satisfied and, in case the needs are not satisfied, output case examples even when coping measures are registered. An exemplary scheme usable in this case is that in case “Product advertising” is implemented as a coping measure, a location at which an article for sale that is indicated by such product ad is put on exhibition is stored or recorded, thereby enabling judgment of whether the need of a customer is satisfied due to the “Product ad” by specifying whether s/he moves to such the location.

While the illustrative embodiment is arranged so that all the case examples for the needs are displayed together on the screen 520 in a table format, keyword-based searching may be conducted for the contents of remarks in cases where the number of the case examples exceeds a predetermined number.

The case example output device 20 is modifiable to accept entry of ideas for application of case examples from the service planner and store therein the accepted application ideas incidental to the case examples and display them on the screen 520 together with the case examples.

Alternatively the case example output device 20 may be arranged to accept, from the service planner or a person who implements coping measures, entry of opinions on difficulties in the case of employing actual examples at the store 1 and store the accepted opinions in association with the case examples for displaying them on the screen 520 along with the case examples.

The image analyzing device 10 may be designed to perform the specifying of the action contents in addition to the behavior of shopping persons. In this case, the case example output device 20 is arranged to accept the input of action patterns from the image analyzing device 10.

While this invention has been described with reference to specific embodiments, the description is illustrative of the invention and is not to be construed as limiting the invention. Various modifications and applications may occur to those skilled in the art without departing from the true spirit and scope of the invention. Obviously, any available equivalents thereof are also included in the coverage of the invention as defined by the appended claims.

According to the invention as disclosed and claimed herein, it is possible to output case examples relative to customer needs.

It should be further understood by those skilled in the art that although the foregoing description has been made on embodiments of the invention, the invention is not limited thereto and various changes and modifications may be made without departing from the spirit of the invention and the scope of the appended claims.

1. An information processing apparatus for outputting case examples in past, said apparatus comprising:
an output device;
an action needs storage unit for storing therein needs information indicative of needs of customers to correspond with action information indicating action contents of the customers at a providing location of a service;
a case example database for storage of said needs information and case example information representing case examples in past with respect to said needs to correspond with each other;
a needs acquisition unit for receiving input of said action information and for reading from said action needs storage unit said needs information corresponding to the received action information;
a case example acquisition unit for reading from said case example database said case example information corresponding to said needs information which is read; and
a case example output unit for outputting to said output device said case example information which is read in a list format.

2. The information processing apparatus according to claim 1, further comprising:
a coping measure information storage unit for storing coping measure information indicative of more than one coping measure being implemented at said providing location to correspond with said needs information, wherein
upon readout of said case example information corresponding to said needs information, said case example acquisition unit determines whether said coping measure information corresponding to said needs information is registered to said coping measure information storage unit and reads said case example information corresponding to said needs information when the corresponding coping measure information is not registered.

3. The information processing apparatus according to claim 1, wherein
said action information contains motion data indicating motions of said customers to be detected at said providing location,
said apparatus includes an action pattern storage unit for storing action patterns which are patterns of said action information, a motion pattern input unit for receipt of input of a motion pattern which is a pattern of said motion data, and an action pattern specifier unit for specifying a detection pattern in which a pattern of said motion data as contained in said action information which is one of said action patterns being stored in said action pattern storage unit matches said motion pattern, and
said needs acquisition unit reads from said needs information storage unit said needs information corresponding to a respective one of said action information making up said detection pattern.

4. The information processing apparatus according to claim 3, further comprising:
a coping measure information storage unit for storing coping measure information representing a coping measure or measures being implemented at said providing location to correspond with said needs information; and
a coping measure list output unit for specifying from said action needs storage unit said needs information corresponding to said action information with respect to each of said action information making up said detection pattern, for reading from said coping measure information storage unit said coping measure information corresponding to the specified needs information, and for outputting to said output device said action information and said coping measure information to correspond with each other.

5. The information processing apparatus according to claim 4, wherein
said motion data making up said motion pattern is added position information indicating a position at said providing location,
said coping measure information storage unit stores said position information indicating a position at which said coping measure is implemented in addition to said needs information and said coping measure information, and
said coping measure list output unit specifies from said action needs storage unit said needs information corresponding to said action information which matches said motion pattern in relation to each of said motion data making up said motion pattern, and reads from said coping measure information storage unit said coping measure information corresponding to said position information as added to the specified needs information and said motion data.

6. The information processing apparatus according to claim 3, wherein
said action needs storage unit stores said needs information while letting it correspond to industry type information indicating an industry type of said service and said action information,
said action pattern storage unit stores said action pattern in a way corresponding to said industry type information,
said motion pattern input unit receives input of said motion pattern along with said industry type information,
said action pattern specifier unit specifies said detection pattern from said action pattern corresponding to said industry type information, and
said needs acquisition unit reads out of said needs information storage unit said needs information corresponding to each of said action information making up said detection pattern and said industry type information.

7. The information processing apparatus according to claim 1, wherein said apparatus is communicably connected to a motion detection device for detecting motions of said customers at said providing location,
said action information contains motion data indicating motions of said customers to be detected at said providing location,
said apparatus includes an action pattern storage unit for storage of action patterns which are patterns of said action information, a motion pattern receiver unit for receipt of a motion pattern which is a pattern of said motion data to be sent from said motion detection device, and an action pattern specifier unit for specifying a detection pattern in which one of said action patterns stored in said action pattern storage unit which is contained in said action information matches said motion pattern, and
said needs acquisition unit reads out of said needs information storage unit said needs information corresponding to each of said action information making up the specified detection pattern.

8. The information processing apparatus according to claim 1, wherein said apparatus is connected to a camera as installed at said providing location and comprises:
an image data acquisition unit for obtaining image data from said camera;
an image analzing unit for analyzing said image data to thereby generate a motion pattern which is a pattern of motion data indicative of motions of said customers;
an action pattern storage unit for storing an action pattern which is a pattern of said action information; and
an action pattern specifier unit for specifying a detection pattern in which a pattern of said motion data as contained in said action information which is one of said action patterns being stored in said action pattern storage unit matches said motion pattern, and
said needs information acquisition unit reads from said needs information storage unit said needs information corresponding to each of said action information making up the specified detection pattern.

9. A method for output of a case example in past, wherein a computer having a CPU, a memory and an output device performs:
storing, in said memory, needs information indicative of needs of customers to correspond with action information indicating action contents of the customers at a providing location of a service;
storing in said memory said needs information and case example information representing earlier case examples for said needs to correspond with each other;
upon receipt of input of said action information, reading from said memory said needs information corresponding to the received action information;
reading from said memory said case example information corresponding to said needs information thus read; and
outputting said case example information which is read to said output device in a list format.

10. The case example output method according to claim 9, wherein said computer performs:
storing, in said memory, coping measure information representing a coping measure being implemented at said providing location to correspond with said needs information; and
when said coping measure information corresponding to said needs information as read out of said action needs storage unit is not registered to said coping measure information storage unit, reading said case example information corresponding to said needs information.

11. The case example output method according to claim 9, wherein
said action information contains motion data indicating motions of said customers to be detected at said providing location,
said computer performs storing, in said memory, action patterns which are patterns of said action information, receiving input of a motion pattern which is a pattern of said motion data, specifying a detection pattern in which a pattern of said motion data as contained in said action information which is one of said action patterns being stored in said memory matches said motion pattern, and reading from said needs information storage unit said needs information corresponding to a respective one of said action information making up the specified detection pattern.

12. The case example output method according to claim 11, wherein said computer performs:
storing coping measure information representing a coping measure or measures being implemented at said providing location to correspond with said needs information;
specifying from said memory said needs information corresponding to said action information with respect to each of said action information making up said detection pattern;
reading from said memory said coping measure information corresponding to the specified needs information; and
outputting to said output device said action information and said coping measure information in a list format to correspond with each other.

13. A program for output of more than one case example in past, said program causing a computer with a CPU, a memory and an output device to perform an operation including the steps of:
storing, in said memory, needs information indicative of needs of customers to correspond with action information indicating action contents of the customers at a providing location of a service;
storing in said memory said needs information and case example information representing earlier case examples against said needs to correspond with each other;
upon receipt of input of said action information, reading from said memory said needs information corresponding to the received action information;
reading from said memory said case example information corresponding to said needs information thus read; and
outputting said case example information which is read to said output device in a list form.

14. The case example output method according to claim 13, wherein the operation of said computer includes the steps of:
storing, in said memory, coping measure information representing a coping measure being implemented at said providing location to correspond with said needs information; and
when said coping measure information corresponding to said needs information as read out of said action needs storage unit is not registered to said coping measure information storage unit, reading said case example information corresponding to said needs information.

15. The case example output method according to claim 13, wherein
said action information contains motion data indicating motions of said customers to be detected at said providing location, and
the operation of said computer includes the steps of:
storing in said memory action patterns which are patterns of said action information;
receiving input of a motion pattern which is a pattern of said motion data;
specifying a detection pattern in which a pattern of said motion data as contained in said action information which is one of said action patterns being stored in said memory matches said motion pattern; and
reading from said needs information storage unit said needs information corresponding to a respective one of said action information making up the specified detection pattern.
